(19) United States
(12) Patent Application Publication
(10) Pub. No.: US 2012/0008222 A1
(43) Pub. Date: Jan. 12, 2012

(54) STRUCTURAL MATERIALS WITH ANGLE DEPENDENT COLOR

(76) Inventor: Ching-Hua Tseng, Belmont, MA (US)

(21) Appl. No.: 13/180,983

(22) Filed: Jul. 12, 2011

Related U.S. Application Data
(60) Provisional application No. 61/363,633, filed on Jul. 12, 2010.

(51) Int. Cl. G02B 5/08

(52) U.S. Cl. 359/839

(57) ABSTRACT

Provided herein are materials with angle-dependent solar radiation absorptivity, reflectivity, or emissivity. In some embodiments, the material exhibits angle-dependent reflectivity and angle-dependent emissivity. The material can appear as one color or a uniform color to an observer. In some embodiments, the material appears to have different colors from different angles of viewing.

### CROSS REFERENCE TO RELATED APPLICATION

This application takes priority from and claims the benefit of Provisional Application Ser. No. 61/363,633 filed on Jul. 12, 2010 the contents of which are hereby incorporated by reference.

### AREA OF TECHNOLOGY

Materials are provided that have improved seasonal solar thermal performance.

### BACKGROUND

Increasing the solar reflectance of surfaces (albedo) has been suggested Rosenfeld, Akbari, Menon, Chu) as part of a strategy to reduce global warming, urban heat islands, and air conditioning burdens. In particular, it has been suggested that painting urban rooftops and roadways white would cool the world, offset CO2 production, and delay global warming. Incoming solar radiation, if reflected, goes back out to space; but if absorbed, gets converted to heat and is subject to trapping. Characteristics of merit for a cool roof are high emissivity and high reflectivity. High emissivity materials radiate heat well, while high reflectivity materials reflect light well. Generally, a dull, black surface has an emissivity near 1, whereas a shiny reflective surface has an emissivity approaching 0. Aluminum sheet has an emissivity of around 0.1, whereas dark asphalt has an emissivity of around 0.9, for example. Cool roof material should reflect solar radiation and not hold heat. White plaster and white paint do well on both counts, having emissivities near 0.9 and solar reflectances of 0.8-0.9. This simple idea of white building surfaces has been practiced for thousands of years in Egypt and Greece, for example.

An average 1000 sq ft of white roof replacing a dark roof offsets 10 tons of CO2 emission over the 20-year lifetime of the roof. This is equivalent to eliminating the emissions from one car for 2.5 years. This whitening, if implemented in the 100 largest cities in the world, would be equivalent to removing all the cars in the world from the road for 10 years. There are advantages to this strategy at the individual building, city, and global levels.

There have been multiple criticisms to the white roof approach, however. A white roof, beneficial in the summer, would incur a penalty in the winter when a dark roof is desired. In Boston, Mass., the winter penalty is about 15% of the savings of the cost of cooling), and Birmingham Ala., it is 5% [Rosenfeld (on the World Wide Web at loe.org/shows/segments.htm?programID=09-P13-00007&segmentID=7]. Furthermore, there are also aesthetic objections to white roofs, although common in many countries such as Greece, Italy, and Bermuda. Indeed, some areas have zoning restrictions or regulations against white rooftop modifications. Efforts have been made to develop visually colored paints that have thermal properties similar to white paint. These paints have high reflectivity in the infrared region of the spectrum. See for instance U.S. Pat. No. 7,157,112.

U.S. Pat. No. 3,001,331 by D. C. Brunton, Sep. 26, 1961 describes a step-like roof material.

U.S. Pat. No. 4,217,742 by Daniel D. Evans, Aug. 19, 1980 describes a louver-like roof structure that has shaded sections.

### SUMMARY OF THE INVENTION

Provided herein are materials that are absorbing to winter solar radiation and light and reflecting to summer solar radiation and light. The materials are suitable for use, for example, on building surfaces that are exposed to sunlight, such as roofs and walls.

Structures comprising a base layer and a coating material are provided. In some embodiments, the coating material exhibits a reflective surface and an absorptive surface, such that the structure exhibits angle dependent reflectivity and emissivity to electromagnetic radiation.

The various embodiments described herein can be complimentary and can be combined or used together in a manner understood by the skilled person in view of the teachings contained herein. There has thus been outlined, rather broadly, the more important features of structural materials with angle dependent color in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF DRAWINGS

FIG. 1A is a section view of a pitched roof with one embodiment of the technology provided herein.

FIG. 1B is a street level view of a pitched roof with one embodiment of the technology provided herein.

FIG. 1C is aerial view of a pitched roof with one embodiment of the technology provided herein.

FIG. 2 is a partial section view of a pitched roof with another embodiment of the technology provided herein.

FIG. 3 is a partial section view of a pitched roof with another embodiment of the technology provided herein.

FIG. 4 is a partial section view of a horizontal roof with another embodiment of the technology provided herein.

FIG. 5 is a partial section view of a pitched roof with another embodiment of the technology provided herein.

FIG. 6 is a graph of the recorded experimental behavior of a various lenticular materials as provided herein.

### DETAILED DESCRIPTION OF THE INVENTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Provided herein are materials with angle-dependent solar radiation absorptivity, reflectivity, or emissivity. In some embodiments, the material exhibits angle-dependent reflectivity and angle-dependent emissivity. The material can appear as one color or a uniform color to an observer. In some embodiments, the material appears to have different colors from different angles of viewing.

In some embodiments, the material exhibits different colors at different angles and has substantially uniform reflectivity and or emissivity. In some embodiments, the material has high reflectivity and/or emissivity and exhibits different colors at different angles of viewing.

As described herein, in some embodiments, the material exhibits a high far-infrared reflectance, high solar absorption surface to low angle winter sunrays, and a high far-infrared emissivity, low solar absorption surface to high angle summer rays. In this manner, the benefits of seasonal solar thermal performance are achieved. Specifically, the aforementioned winter penalty would be reduced because the roof would look black in the winter. In some embodiments, the street level appearance of the roof would also be black. In some embodiments, the structures and/or materials provided herein exhibit an angle-dependent surface color. In some embodiments, the material has varying reflective and emissive properties in the infrared region of the spectrum, and exhibits a uniform surface color.

Reflectance and emittance values for typical roofing materials are: Black paint R=0.05, E=0.9, new asphalt R=0.05, E=0.9, traditional black asphalt shingle R=0.05, E=0.93, white asphalt shingle R=0.21, E=0.91, white acrylic paint R=0.8, E=0.9, white plaster R=0.95, E=0.90. Higher reflectance materials include: advanced white asphalt shingle R=0.60; cool colored shingles R=0.40; clay tiles R=0.42-0.68. (source: on the World Wide Web at concretethinker.com/solutions/Heat-Island-Reduction.aspx; steab.org/docs/Cool_Roofing_Technologies.pdf; and reliant.com/en_US/Page/Shop/Public/esc_oma_cool_roofs_bus_shp.jsp). Solar reflectance and thermal emittance values can be measured using ASTM procedures as designated by the CRRC (Cool Roof Rating Councilon the World Wide Web at coolroofs.org). For instance, the CRRC allows ASTM test methods C1549, E1918, and E903 and CRRC Test Method #1 to measure Solar Reflectance and ASTM C1371 to measure Thermal Emittance. (source: on the World Wide Web at eetd.lbl.gov/HeatIsland/CoolRoofs/HeatTransfer/#Sunlight; and eetd.lbl.gov/coolroof/ref_{—}01.htm).

Suitable materials for the technology provided herein can have a reflectance >0.7, and emittance >0.75.

The angle-dependence is determined by the path of the sun in the sky at a given geographic location. At the equinoxes, the path of the sun falls in a plane passing through the observer and tilted at an angle equal to the latitude of the position. At other times, the path of the sun falls on a cone with extreme angles from the equatorial at the solstices given by the tilt of the earth. Thus, as is known from equatorial or equinoctial sundial construction, a face of a plane that is aligned with the equatorial plane will not have a clear shadow cast upon it during the equinoxes; whereas in winter the shadow of the gnomon will be cast on one side, and in summer the opposite. For low angle sunlight, the angle of sunlight at the fall equinox is 90 degrees minus the latitude (in the Northern hemisphere); this decreases by the amount of the earth's tilt (23.5 degrees) at the winter solstice. For example, for latitude 50 degrees North the angle of sunlight is 40 degrees at the equinox to 16.5 degrees at the winter solstice. For high angle sunlight, the angle of sunlight at the spring equinox is again 90 degrees minus the latitude (in the Northern hemisphere); this increases by the amount of the earth's tilt (23.5 degrees) at the summer solstice. For example, for latitude 50 degrees North the angle of sunlight is 40 degrees at the equinox to 63.5 degrees at the summer solstice. (source: on the World Wide Web at.physicalgeography.net/fundamentals/6h.html).

Thus, a material that substantially presents a white surface to viewing angles above the equatorial plane, and black below it, would reflect solar radiation in the summer and absorb such radiation in the winter. The angle-dependence of the material may be adjusted to account for seasonal thermal lag.

As provided herein, there are multiple ways to achieve this angle-dependence including use of suitable coating materials, suitable structures, and combinations thereof. Suitable coating materials include, but are not limited by, modified retroreflective materials, optical spheres, microprismatic particles, compound parabolic mirrors, and lenticular printing materials. Suitable structures include louver and villi-like structures.

In some embodiments, the coating material comprises retroreflective microstructures. As provided herein, micro retroreflective materials are modified to comprise one black back surface area and one white or mirrored back surface area. The black surface area of the microstructures is positioned such that it is impinged by low angle sunlight in situ, while the white or mirrored surface area is positioned to be impinged by high angle sunlight in situ.

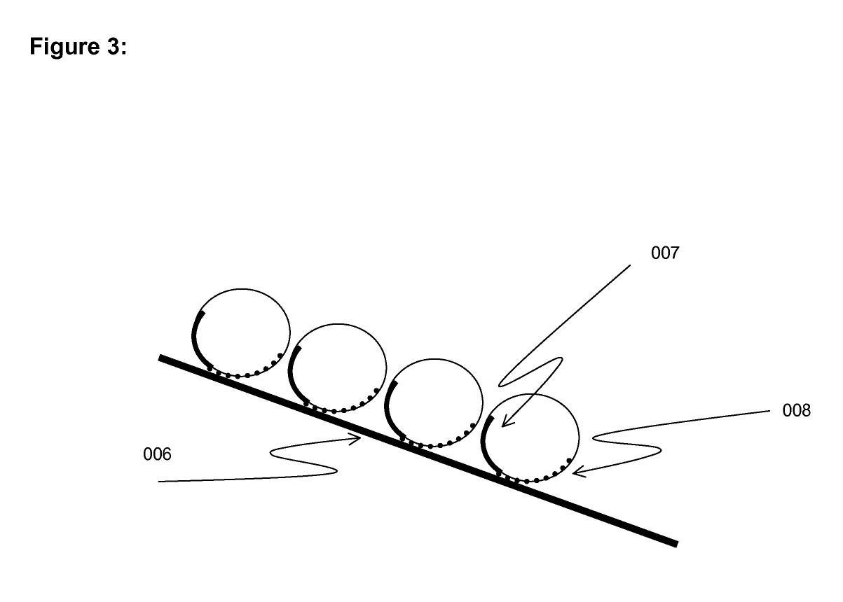

Microstructures are aligned and/or positioned in situ to produce the desired angular effect. For example, as shown in FIG. 3, base structure (or layer) (006) supports retroreflective elements (microstructures) with an absorptive back surface (007) and a reflective back surface (008). In some embodiments, the microstructures comprise material suitable for use on roofs. Any retroreflective material that is suitable for use in building materials such as roofing materials can be used. For example, for a retroreflective element surface coating, a thin aluminum layer could be used for a reflective surface, whereas an aluminum nitride (AlN) coating could be used for the absorptive surface. In another embodiment, the retroreflective element may be composed of an optical glass or ceramic. Suitable sizes may range from tens to thousands of microns. The base layer can be any material that is suitable for use in building materials that can be coated with or otherwise serve as a base for the retroreflective elements. For example, a polymer membrane or other binder material can be used for the base layer.

In some embodiments, the coating material comprises optical spheres. The spheres are embedded into a substrate that is reflective at larger depths, absorptive at shallower depths, and reflective at the topmost surface. The spheres may be comprised of varying index of refraction materials, including but not limited to a hollow air core, Luneburg lens configuration, or step index lens configuration. Suitable optical spheres are those that can be used in building materials. Examples of high index of refraction (n>1.9) optical spheres are manufactured by Flexolite, Swarco, and 3M. Typical sizes are tens to thousands of microns. Typical materials include high index of refraction glass or ceramic. For low slope roofs (less than 2 inches rise per 12 inches run), typical traditional roofing materials include BUR (reflectance 0.15-0.25); modified bitumen roofing (reflectance 0.10-0.20, emittance 0.85-0.95); single ply membranes black (reflectance 0.04-0.05, emittance 0.85-0.95) gray (reflectance 0.15-0.20, emittance 0.85-0.95). Cool roof materials (for example, having reflectance >0.7, emittance >0.75) include: BUR white gravel and cementitious (reflectance 0.30-0.85, emittance 0.80-0.95); white single ply membranes of EPDM white ethylene propylene diene monomer, CSPE chloro-sulfonated polyethylene, PVC poly-vinyl chloride, TPO thermoplastic poly-olefin; (reflectance 0.70-0.80, emittance 0.85-0.95); modified bitumen (reflectance 0.60-0.75, emittance 0.85-0.95). For steep slope roofs, solar reflectance materials range from 0.05-0.3. (source: on the World Wide Web at.pge.com/includes/docs/pdfs/shared/saveenergymoney/rebates/remodeling/coolroof/coolroofdesignbrief.pdf). Thus, for example, a double ply membrane, white on black, may serve as a base material into which the optical spheres are embedded.

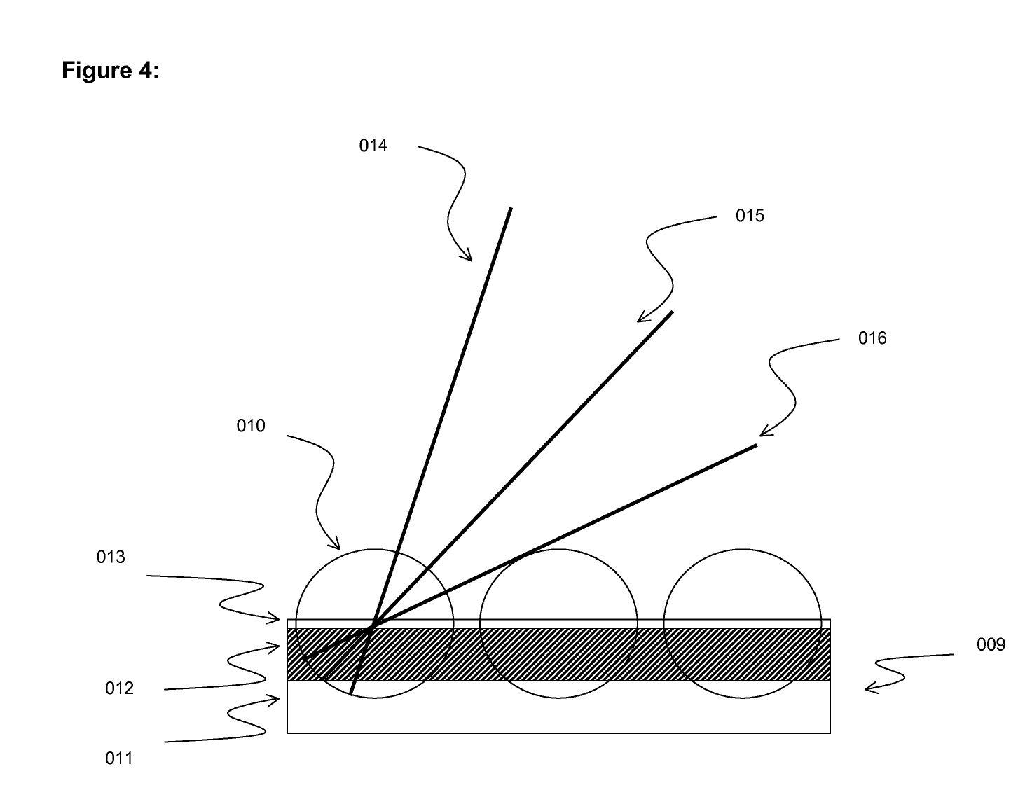

FIG. 4 shows spheres that comprise ball lenses that focus on incident light on to the back surface of the sphere. As shown in FIG. 4, base structure (009) has embedded in it spherical elements (010). The base structure comprises a reflective layer (011), an absorptive layer (012), and a surface layer (013). The summer solstice ray is indicated by (014); the equinox rays by (015); and the winter solstice ray by (016). In some embodiments, the reflective layer is white. In some embodiments, the absorptive layer is black. In some embodiments, the surface layer is white. In some embodiments, spheres embedded in a multi-layered substrate exhibit an angle-dependent color.

Light from the sun between the equinoxes and the winter solstice will impinge on the black surface, thus the optical spheres exhibit an absorbing surface. Light from the sun between the equinoxes and the summer solstice will strike the white surface during the mid-day, but will strike the black surface during the morning and late afternoon hours. The extent of the white appearance will be greater near the summer solstice than near the equinoxes. Therefore, this configuration will not only present a seasonally progressive black-white surface as the angle of the sun changes, but also an increasingly dominant white surface at mid-day as the seasons approach the summer solstice peak. The particular behavior can be adjusted by changing the depth of insertion of the sphere relative to the thickness of the black-white layers. Additionally, an inclined surface can be accommodated by similar adjustments.

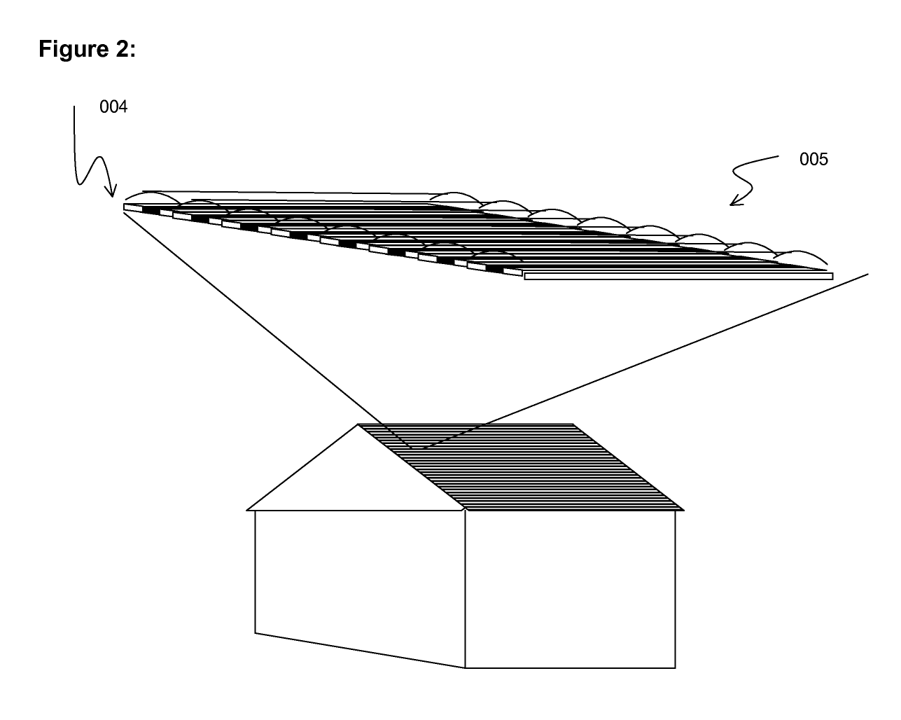

In some embodiments, the coating material comprises lenticular optics. As shown in FIG. 2, an interlaced reflective and absorptive image (004) is placed below a lenticular lens (005). Lenticular printing is based on a cylindrical lens array laminated on an interleaved printed backdrop. The lenses at a given viewing angle bring one subset of the printed pattern into focus, and thus provide an image for the given angle. Another image is apparent at another viewing angle. Manufacturing technology uses a printed roll process.

In one embodiment of the technology provided herein, one subset of the printed pattern exhibits a black ‘image’ at low incident angles of light, and another subset of the printed pattern exhibits a white or retroreflective ‘image’ for high incident angles of light.

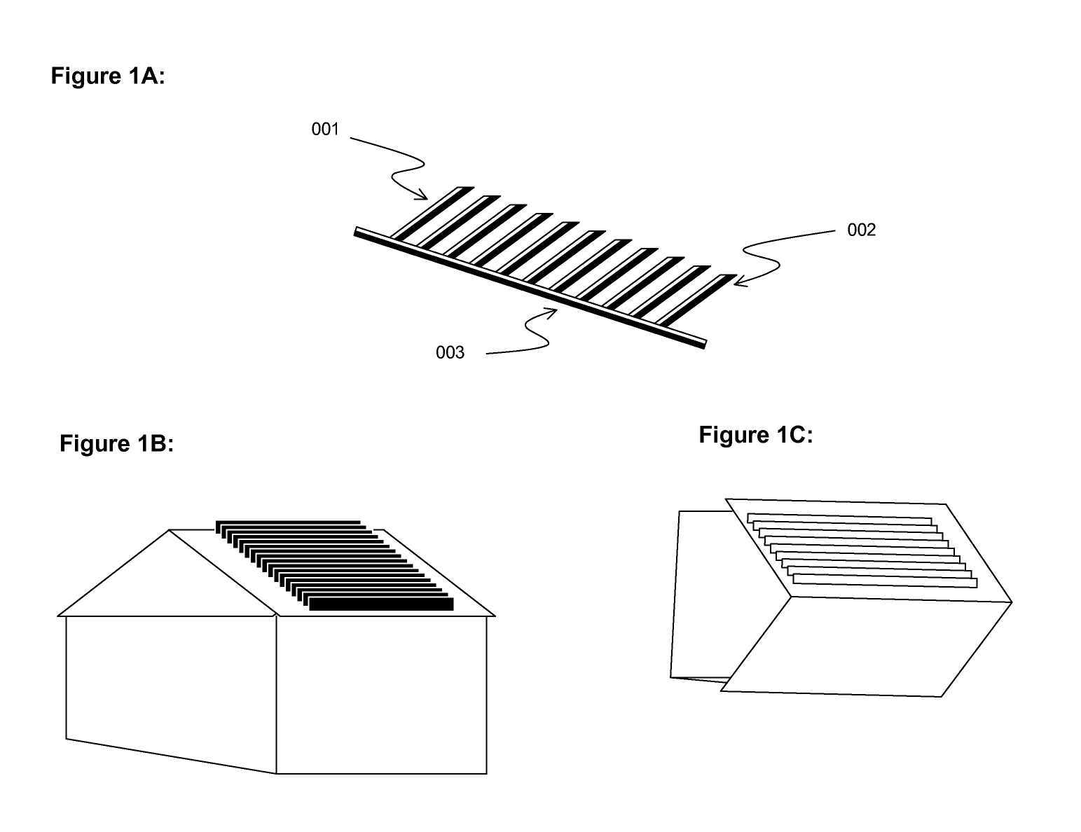

In some embodiments, the structure comprises a louver structure. As shown in FIG. 1A, a reflective material (001) forms the upper surface of the louver, whereas an absorptive material (002) forms the lower surface of the louver. Each louver is attached to a reflective base structure (003).

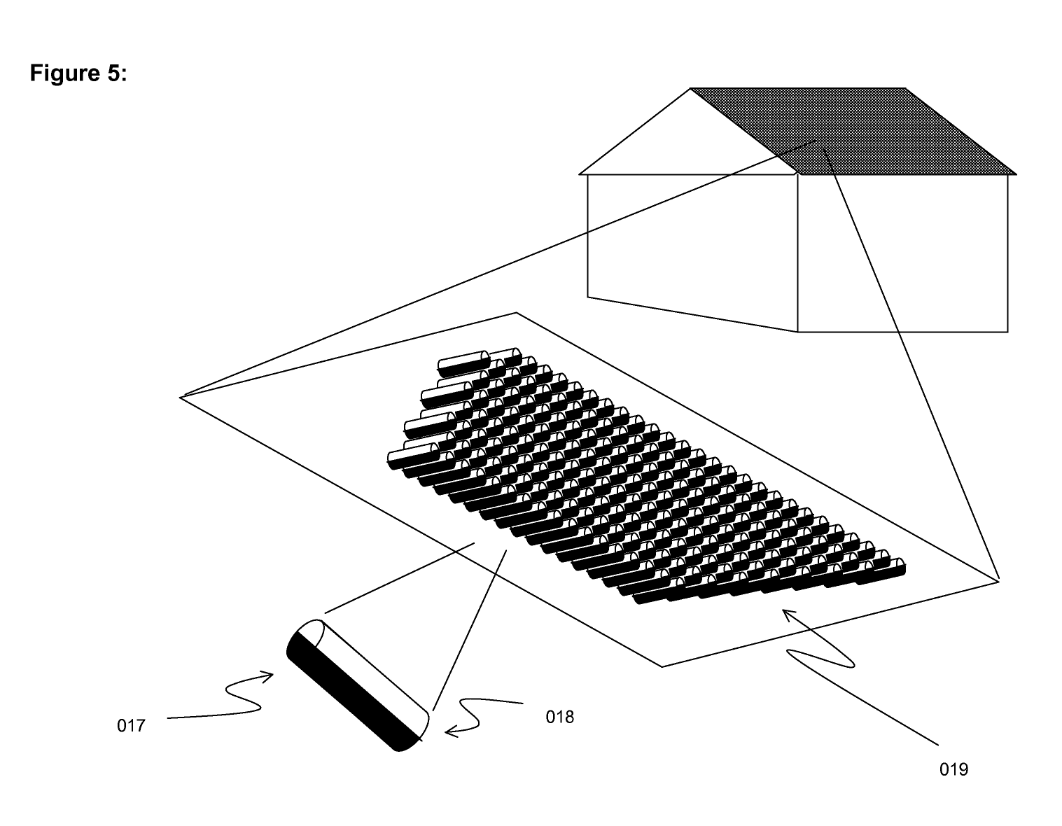

In some embodiments, the structure comprises villi-like structures. As shown in FIG. 5, each of the villi has a dark side (017) and a light side (018). The villi are arranged in an array (019) that presents a predominantly black surface from lower perspectives and a predominantly white surface from higher perspectives.

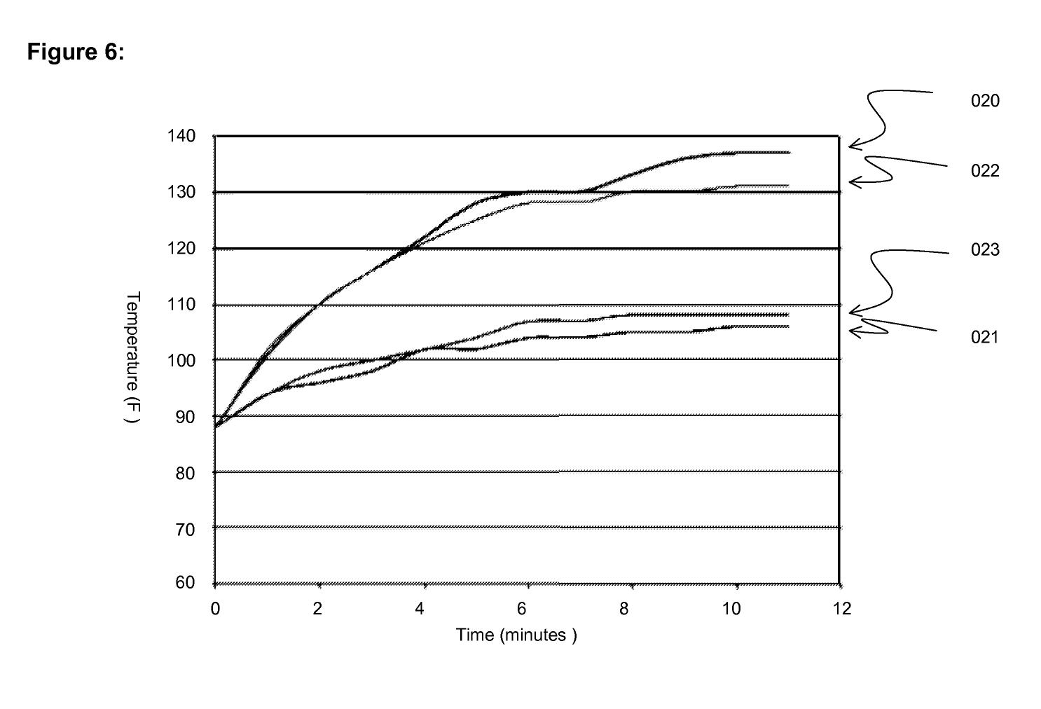

FIG. 6 shows the surface temperature response of black (020), white (021), apparent black (022), and apparent white (023) lenticular tiles placed in direct sunlight. The black tile is a lenticular sheet with a complete black backing. The white tile is a lenticular sheet with a complete white backing. The apparent black lenticular sheet is a lenticular sheet with black and white stripes, but placed at an angle in the sunlight as to appear black. The apparent white lenticular sheet is a lenticular sheet with black and white stripes, but placed at an angle in the sunlight as to appear white. The ambient temperature was 88 C. After 11 minutes, the black lenticular tile reached a temperature similar to the black tile, and the white lenticular tile reached a temperature similar to the white lenticular tile.

The methods and systems set forth here may be used, but are not limited to, for covering a building roof, wall, roadway, vehicle surface, or clothing. The systems and methods described herein can also be used, for example, to cover a flat roof, with variations to permit drainage. Optimal alignment would be along the East-West axis. For the case of the embedded spheres, the elements would not have to be aligned as they are symmetrical.

The invention having been fully described, it will be apparent to one of ordinary skill in the art that many modifications and changes may be made to it without departing from the spirit and scope of the technology provided herein as defined by the appended claims.

### REFERENCES

Akbari, H., S. Menon, and A. Rosenfeld: LBNL study available on the World Wide Web at energy(dot)ca(dot)gov/2008publications/CED-999-2008-031/CEC-999-2008-031.pdf
Rosenfeld, Bruce: interview on Living On Earth, Painting the Town White, Feb. 13, 2009, available on the world wide web at loe(dot)org/shows/segments.htm?programID=09P13-00007&segmentID=7.

What is claimed is:

1. A structure comprising:
a base layer; and
a coating material, wherein the coating material exhibits a reflective surface and an absorptive surface, such that the structure exhibits angle-dependent reflectivity and emissivity to electromagnetic radiation.

2. The structure of claim 1, wherein the structure exhibits angle-dependent color.

3. The structure of claim 1, wherein the reflective and absorptive surfaces are aligned with respect to an angle of latitude at a location of the structure.

4. The structure of claim 1, wherein the reflective surface is aligned such that the structure substantially reflects sunlight in summer.

5. The structure of claim 1, wherein the absorptive surface is aligned such that the structure substantially absorbs sunlight in winter.

6. The structure of claim 1, wherein the reflective surface and absorptive surfaces are integrated in a lenticular optic structure.

7. The structure of claim 1, wherein the reflective and absorptive surfaces are integrated in a retroreflective optic structure.

8. The structure of claim 1, wherein the reflective and absorptive surfaces are integrated in a villi-like structure.

9. The structure of claim 1, wherein the structure is comprised of optical spheres partially embedded in alternating white and black layers.

10. A structure comprising a reflective surface and an absorptive surface, wherein the surfaces are on opposing sides of louvers with the reflective surface above the absorbing surface, wherein the louvers are horizontally placed and fixed to a base layer, such that the structure exhibits angle-dependent reflectivity and emissivity to electromagnetic radiation.

11. The structure of claim 10, wherein the base layer is reflective.
